(19) United States
(12) Patent Application Publication
(10) Pub. No.: US 2013/0117647 A1
(43) Pub. Date: May 9, 2013

(54) SYSTEMS AND METHODS FOR COMPLETING A LOAN APPLICATION ON A MOBILE TECHNOLOGY PLATFORM

(71) Applicant: Andrew WeissMalik, Austin, TX (US)

(72) Inventor: Andrew WeissMalik, Austin, TX (US)

(21) Appl. No.: 13/673,960

(22) Filed: Nov. 9, 2012

Related U.S. Application Data
(60) Provisional application No. 61/557,542, filed on Nov. 9, 2011.

(51) Int. Cl. G06F 17/00

(52) U.S. Cl. 715/205

(57) ABSTRACT

A mobile technology platform (403) for processing loan applications is provided which includes a display and a non-transitory, computer-readable medium. The medium has recorded therein a software program containing suitable programming instructions which, when executed, causes to be displayed on the display a screen having (a) an index portion (243) with a plurality of index items listed therein, wherein each index item pertains to a loan-related topic, and (b) a page display portion (225). Each of said plurality of index items is linked to a page having disposed thereon at least one fillable field relating to a loan application topic. Selecting one of said at least one index items causes the corresponding linked page to be displayed on the page display portion.

### CROSS-REFERENCE TO RELATED APPLICATION

The present application claims the benefit of priority of U.S. Provisional Application 61/557,542 (WeissMalik), entitled “Systems and Methods for Completing a Loan Application on a Mobile Technology Platform”, which was filed on Nov. 9, 2011, and which is incorporated herein by reference in its entirety.

### FIELD OF THE DISCLOSURE

The present disclosure relates generally to the processing of loan applications, and more particularly to systems and methods for processing a loan application on mobile technology platforms.

### BACKGROUND OF THE DISCLOSURE

Various software programs are known to the art which are designed to help users complete or prepare various forms or documents. For example, Intuit (Mountain View, Calif.) offers a suite of products under the TurboTax® mark that assist the user in filling out tax forms and completing tax returns. In some versions of the software, the user may access a screen containing a list of topics that need to be addressed in order to complete a form or tax return, and the screen allows the user to browse to a particular topic by selecting an item on the list.

Various types of mobile communications devices, mobile computing devices and other such mobile technology platforms are also known to the art. The use of such devices has become ubiquitous in the business world, where they are used in various settings for a variety of purposes.

### BRIEF DESCRIPTION OF THE DRAWINGS

FIGS. 1-19 are screenshots from a particular, non-limiting embodiment of a software program in accordance with the teachings herein.

FIG. 20 is an illustration of a particular, non-limiting embodiment of a system in accordance with the teachings herein and over which the foregoing software program may be implemented.

### SUMMARY OF THE DISCLOSURE

In one aspect, a mobile technology platform is provided which comprises a display and a non-transitory, computer readable medium. The medium has recorded therein a software program containing suitable programming instructions which, when executed, causes to be shown on the display a screen having (a) an index portion with a plurality of index items listed therein, and (b) a page display portion. Each of said plurality of index items is linked to a page having disposed thereon at least one field relating to a loan application topic. Selecting one of said at least one index items causes the corresponding linked page to be displayed on the page display portion.

In another aspect, a system is provided which comprises a plurality of mobile technology platforms, a server in communication with each of said plurality of mobile technology platforms over a network, and a database in communication with said server. Each of the plurality of mobile technology platforms has an instance of a client resident thereon and is equipped with a display. The client, which is preferably recorded in a non-transitory, computer readable medium, contains suitable programming instructions which, when executed, causes to be shown on the display a screen having (a) an index portion with a plurality of index items listed therein, and (b) a page display portion. Each of the plurality of index items is linked to a page having disposed thereon at least one field relating to a loan application topic. Selecting one of said at least one index items causes the corresponding linked page to be displayed on the page display portion.

In a further aspect, a method for completing a loan application is provided. The method comprises (a) providing a mobile technology platform equipped with a display and a non-transitory, computer readable medium having recorded therein a software program containing suitable programming instructions which, when executed, causes to be displayed on the display a screen having (a) an index portion with a plurality of index items listed therein, wherein each index item pertains to a loan-related topic, and (b) a page display portion; wherein each of said plurality of index items is linked to a page having disposed thereon at least one fillable field relating to said loan application topic, and wherein selecting one of said at least one index items causes the corresponding linked page to be displayed on the page display portion; and (b) for each index item, (i) selecting the index item, and (ii) entering information in the page display portion corresponding to the index item.

### DETAILED DESCRIPTION

Despite the proliferation of mobile technology platforms, there is still a need in the art for systems and methodologies which can leverage these devices in many applications. This is especially true in the processing of loan applications, where the freedom of movement offered by mobile technology platforms would allow users to complete loan applications at locations of convenience, which might include banks, credit unions, brokerage houses, title insurance companies, and other such places where the information required to complete the loan application might be available. In addition, the ability to use such devices to complete loan applications would allow users to work on an application while they are away from their home or office. For example, this ability would allow loan officers or agents to work on loans from the home or office of a consumer.

There is a need in the art for systems and methodologies which allow an entire mortgage application to be completed from a mobile technology platform, which allow application data to be transmitted wirelessly to the user's desktop for importing into any loan processing software, which allow credit reports to be pulled from the mobile device, which allow mortgage disclosures to be created directly from the mobile technology platform, which allow applicants to sign mortgage disclosures from the mobile technology platform with their finger, which provide for the placement of advertisements on the mortgage application, and which allow the user to search loan eligibility, and to retrieve interest pricing, directly on the device. These and other needs may be met with the systems, devices, and methodologies and software disclosed herein.

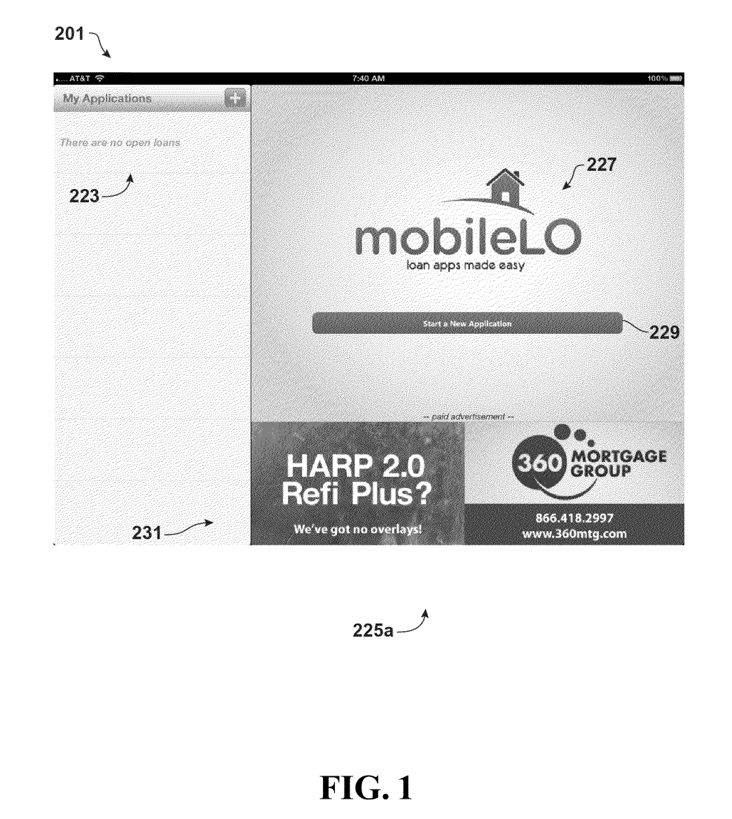

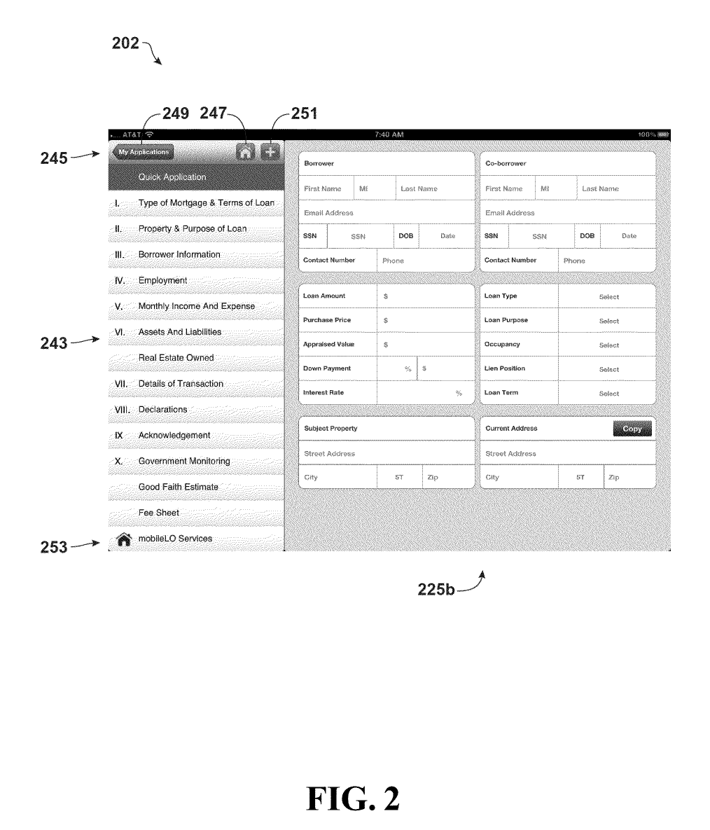

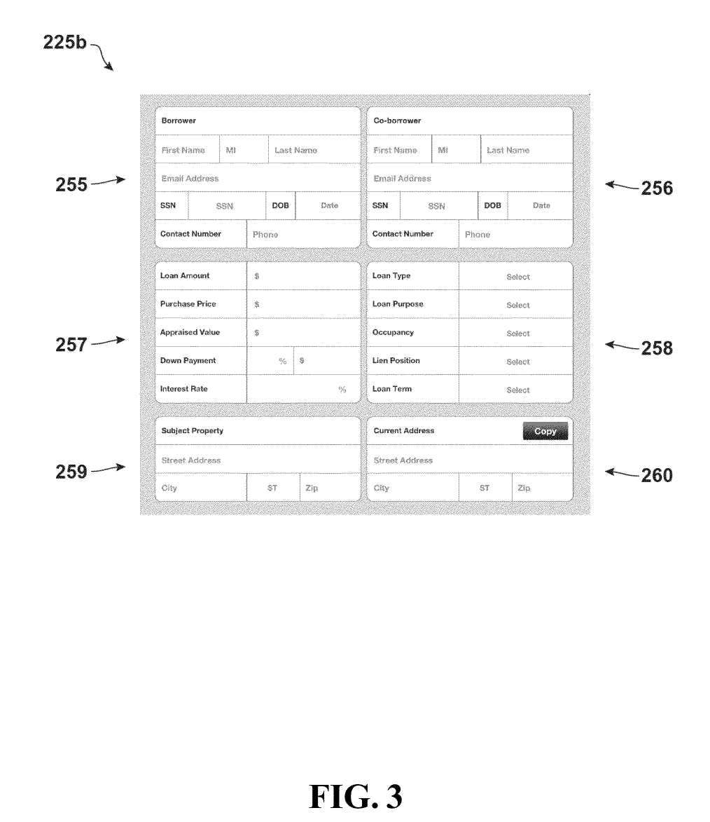

FIGS. 1-19 are screenshots from a first particular, non-limiting embodiment of a software program in accordance with the teachings herein which implements some of these systems and methodologies. For purposes of clarity, in FIGS. 3-19, only the contents of the main program window (shown as the right-hand pane 225b in the screenshot of FIG. 2) are depicted; however, in each case, the remainder of the screen is as depicted in FIG. 2, except that the appropriate subject matter category in the navigational menu 243 is highlighted in each case (in the same manner that the subject matter category “Quick Application” is highlighted in the navigational menu 243 in FIG. 2).

As seen in FIGS. 1-19, the software featured in the embodiment depicted therein produces a series of pages, each of which pertains to a particular loan application topic and contains fields in which the user enters the requested information which is needed to prepare a loan application. In some cases, one or more check boxes or buttons are provided by which the user may indicate a selection or a condition that is applicable to the user. Each page is also equipped with navigation features which allow the user to navigate forwards or backwards through the loan application.

Each page is also further equipped with a navigational menu 243 (see FIG. 2) which contains an index of loan application topics. The user may select an item in this list to navigate directly to the page covering that topic. In some cases, a portion of any particular page may be utilized for advertisements by, for example, third party vendors or business associates of the entity preparing the loan application. Such advertisements may be utilized as a revenue source to subsidize parts of the systems described herein or to provide an additional source of revenue to the entity. The specifics of each page are described in detail below.

FIG. 1 depicts the home page 201 rendered by the software. The home page 201 comprises an expandable loan application menu 223 from which a user can select any one of a group of existing applications to work on (the loan application menu 223 is shown here in an expanded state, and for the case where no open loans are present). The home page 221 further comprises a main program window 225a which, on this particular page, displays a starting screen for the program. The starting screen may be equipped with background graphics 227 relating to the software producer or the company utilizing the software. Such graphics 227 may comprise, for example, various images, vector graphics, textures, logos, slogans, text, and the like. The company utilizing the software may be, for example, a mortgage company, bank, credit union, or other such entity.

The main program window 225a further includes a start button 229 from which the user may launch a new loan application. An advertising section 231 is provided on the bottom portion of the main program window 225a and is reserved for the presentment of banner ads and other advertisements from appropriate parties. Such parties may be, for example, the software producer, the entity utilizing the software, advertisers, or business associates of the foregoing.

FIG. 2 shows the quick application page 202 which is rendered by the software on the display of the host device when the user selects the start button 229 on the home page 201 of FIG. 1. As seen therein, the quick application page 202 features a navigational menu 243 from which the user can navigate to various other pages in the software or loan application. The quick application page 202 further features a navigational toolbar 245 which contains a home page icon 247, an applications icon 249, and a control feature 251. The control feature 251 allows the user to expand or collapse the navigational menu 243. The home page icon 247 allows the user to navigate to the home page 221 (depicted in FIG. 1). The home page 221 may also be accessed from a menu item 253 on the navigational menu 243. The applications icon 249 allows the user to access a menu or folder which lists any existing applications created by the user so that the user can open or modify these applications.

The quick application page 202 further comprises the main program window 225b, shown in greater detail in FIG. 3, in which the user enters general information about the borrower, the co-borrower, and any existing mortgage or loan on the subject property for which a loan application is being generated. The main program window 225b includes borrower 255 and co-borrower 256 information sections, each of which includes fields for inputting information about the borrower and co-borrower such as names, dates of birth, social security numbers, and contact information. The main program window 225b further includes loan information sections 257 and 258, each of which includes fields for inputting information about any existing loan or mortgage on the subject property, including the amount and term of the loan, the type of loan, the purchase price of the property to which the loan relates, the appraised value of the property, the down payment, the current interest rate, the purpose of the loan, the occupancy situation of the property, and the lien position. The main program window 225b further includes address fields 259 for the subject property and address fields 260 for the borrower. A copy button is provided in the address fields 260 for the borrower which, when selected, populates the address fields 260 for the borrower with the information provided in the address fields 259 for the subject property, and thus facilitates completion of the application in the event that the two addresses are the same.

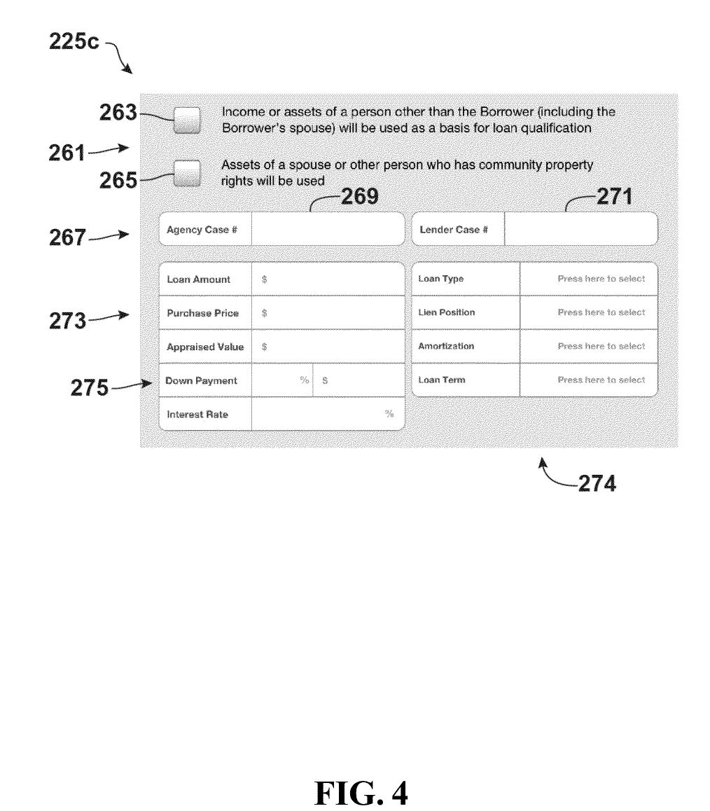

FIGS. 4-16 show further pages rendered by the software program. These pages differ from the quick application page 202 in FIG. 2 only in the content of the main program window 225, and in the highlighting of the corresponding menu item on the navigational menu 243 (see FIG. 2). Hence, for simplicity of illustration, only the content of the main program window 225 is depicted in FIGS. 4-16.

With respect to FIG. 4, the main program window 225c comprises an assets qualification portion 261 in which the user can select any of a series of applicable buttons which describe the assets being used for loan qualification. In the embodiment depicted, these include a first button 263 for users who will be using the assets of others as a basis for loan qualification, and a second button 265 for those who will be using assets, for loan qualification purposes, of a person who has community property rights.

The main program window 225c in FIG. 4 further comprises fields for inputting case information 267. In the embodiment depicted, these include a field for providing an agency case number 269, and a field for providing a lender case number 271.

The main program window 225c in FIG. 4 also comprises loan information fields 273, 274 for inputting loan information relating to an existing loan on a property or asset being used for loan qualification. These loan information fields 273, 274 include fields to input the loan amount, purchase price, appraisal value, interest rate, loan type, lien position, amortization, loan term and down payment. The down payment field 275 includes subfields for expressing the down payment as a percentage of the loan and as a dollar amount. Preferably, if a value for one of these subfields is supplied and the user has already provided sufficient information, the other subfield is automatically populated with the corresponding value. Similarly, it is also preferred that, if one of these fields is modified, the other field is automatically updated with a corresponding value as soon as the modified value is entered.

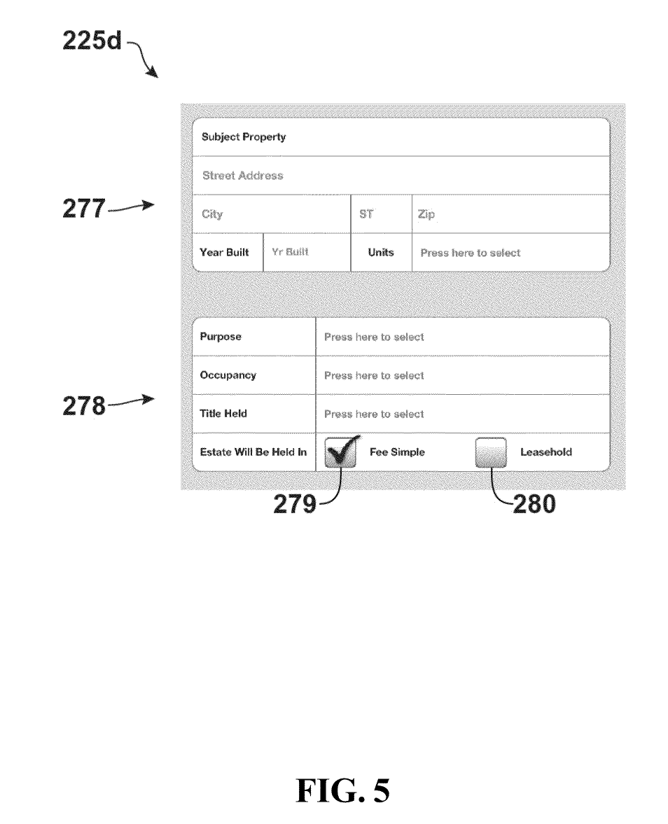

With respect to FIG. 5, the main program window 225d comprises property fields 277 for describing the property to which the loan relates. These fields include an identification of the property (which may include, for example, the name of the owner or a generic description of the property), the address of the property, the year the property was built, and the number of units on the property (if applicable).

The main program window 225d of FIG. 5 further includes title fields 278 for describing attributes of the property title. The title fields 278 include, for example, the purpose the property serves (e.g., residential, business or rental), the occupancy status, the entity that holds the title, and the manner in which the estate will be held. With respect to the latter field, selectable buttons 280 are provided to allow the user to specify whether the property will be held in fee simple or as leasehold.

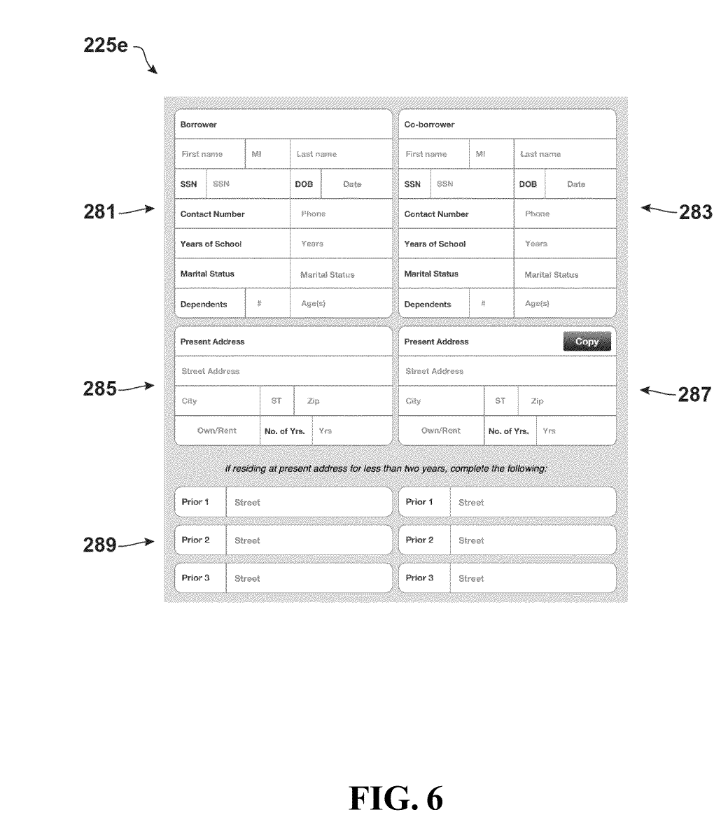

With respect to FIG. 6, the main program window 225e comprises borrower 281 and co-borrower 283 fields which allow the user to enter personal information about the borrower and co-borrower, respectively. This information includes each party's full name, social security number and date of birth, a phone number the party can be reached at, the number of years of school the party attended, the marital status of the party, the number of dependents the party has, and the age of those dependents.

The main program window 225e of FIG. 6 further comprises residence fields 285 and 287 for the borrower and co-borrower, respectively. The residence fields 285, 287 allow the user to enter information about the present addresses of the borrower and co-borrower and the number of years they have lived at that address, and further allow the user to specify whether the borrower or co-borrower owns or rents their residence. A copy button is provided in the residence fields 287 of the co-borrower which may be used to populate these fields with the corresponding information specified for the borrower in the event that the information is the same.

The main program window 225e of FIG. 6 further comprises residence history fields 289, in which the user can specify the residence history of the borrower and co-borrower in the event that either party has not lived in the same residence for at least 2 years.

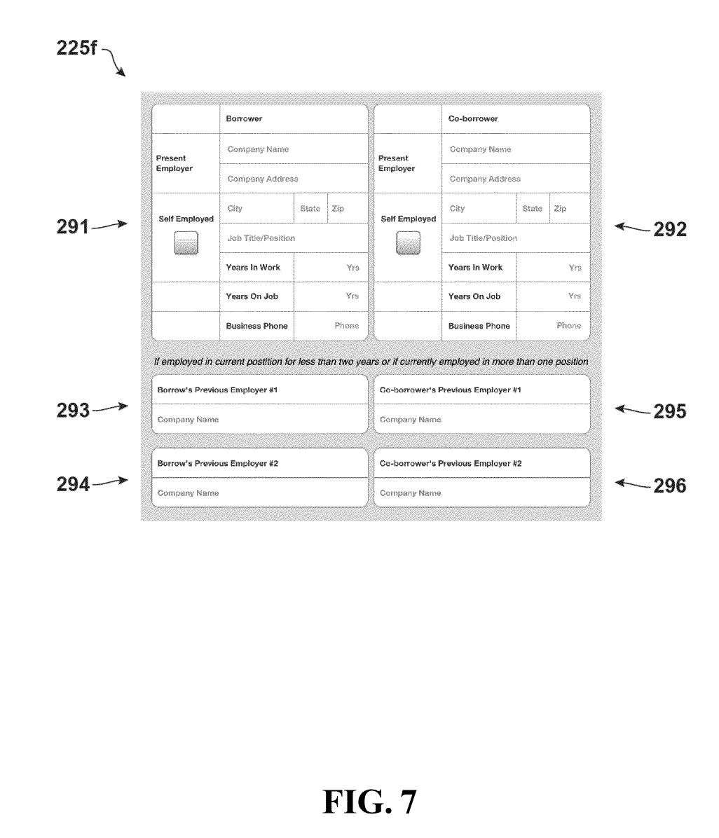

With respect to FIG. 7, the main program window 225f comprises borrower employment fields 291 and co-borrower employment fields 292 which allow the user to enter employment information about the borrower and co-borrower, respectively. Such information includes the name and address of the employer, the title or position the party held, the number of years the party worked for the employer, the number of years the party held the current job title or position with the employer, and the employer's phone number. A selectable self-employed button 297 is provided in each of the borrower employment fields 291 and co-borrower employment fields 292 to allow the user to indicate self-employment.

The main program window 225f of FIG. 7 further comprises borrower employment history fields 293, 294 and co-borrower employment history fields 295, 296 in which the user can specify the employment history of each of these parties in the event that either party has not had the same employer for at least the last 2 years. In some embodiments, the borrower employment history fields 293, 294 and co-borrower employment history fields 295, 296 may be expandable to allow entry of more than two previous employers.

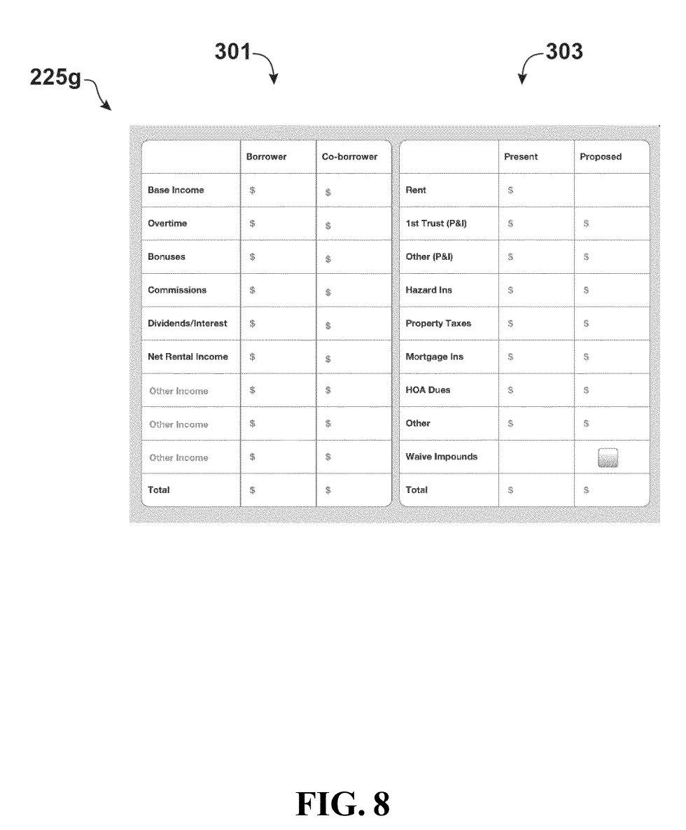

With respect to FIG. 8, the main program window 225g comprises first 301 and second 303 panes in which the user can enter the value of various assets and liabilities associated with the borrower and co-borrower. The items in the first pane 301 include any income received by either party, including the base income of each party, any overtime, bonuses or commissions earned by each party, any dividends or interest received by either party, any net rental income received by either party, and any other income received by either party. The total amounts of the foregoing assets are summed at the bottom of the first pane 301.

The items in the second pane 303 include any liabilities either party has, including the present and proposed amounts of any rent, 1^{st} trusts (principle and interest), other trusts (principle and interest), hazard insurance, property taxes, mortgage insurance, HOA dues, other dues, and the cost of any impounds waived on the loan. The total amounts of the foregoing liabilities are summed at the bottom of the second pane 303.

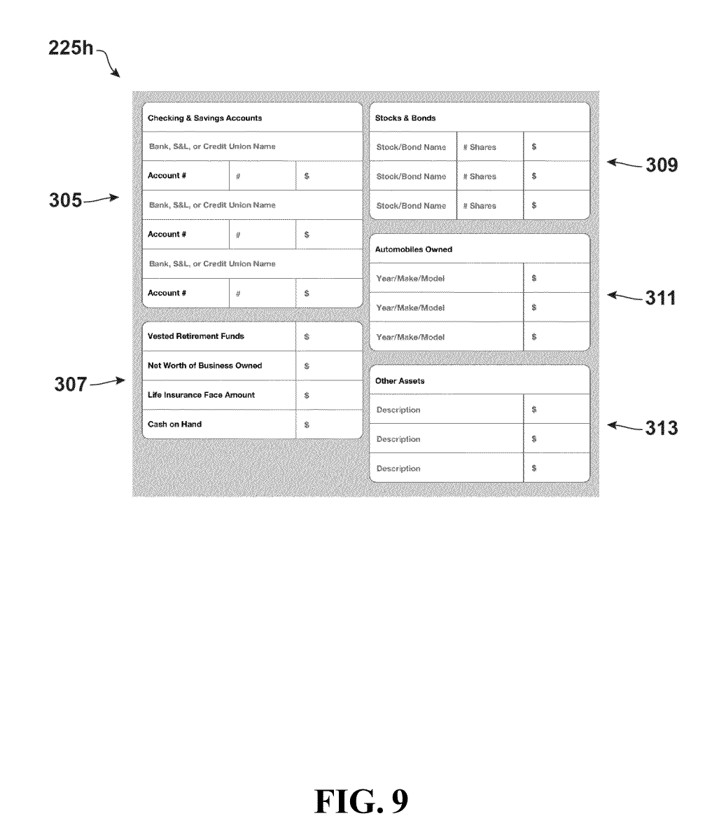

With respect to FIG. 9, the main program window 225h comprises several panes in which the user can enter information about the applicants' assets. These include a first pane 305 in which the user can enter information about checking and savings accounts belonging to applicants, including the name of the bank, S&L or credit union where the account is held, the account number, and the current balance. The main program window 225h on this page further comprises a second pane 307 in which the user can enter information about the balances of the applicants' retirement funds, the net worth of any businesses owned by the applicants, the face amount of any life insurance policies owned by the applicants, and any cash the applicants have on hand, if any. In some embodiments, the first 305 and second 307 panes may be expandable to accommodate the entry of additional accounts and assets, respectively.

The main program window 225h further comprises a third pane 309 in which the user can enter information about any stocks and bonds owned by the applicants, including the names of the stock/bond, the number of shares the applicant owns of each one, and the current dollar value of these securities. In some embodiments, the third pane 309 may be expandable to accommodate the entry of information for additional securities.

The main program window 225h further comprises a fourth pane 311 in which the user can enter information about any vehicles owned by the applicants, including the year, make and model of each vehicle. A fifth pane 313 is provided in which the user can enter information about any assets not entered in one of the other panes, including a description of each asset and the current dollar value of the asset. In some embodiments, the fourth 311 and fifth 313 panes may be expandable to accommodate the entry of additional vehicles and assets, respectively.

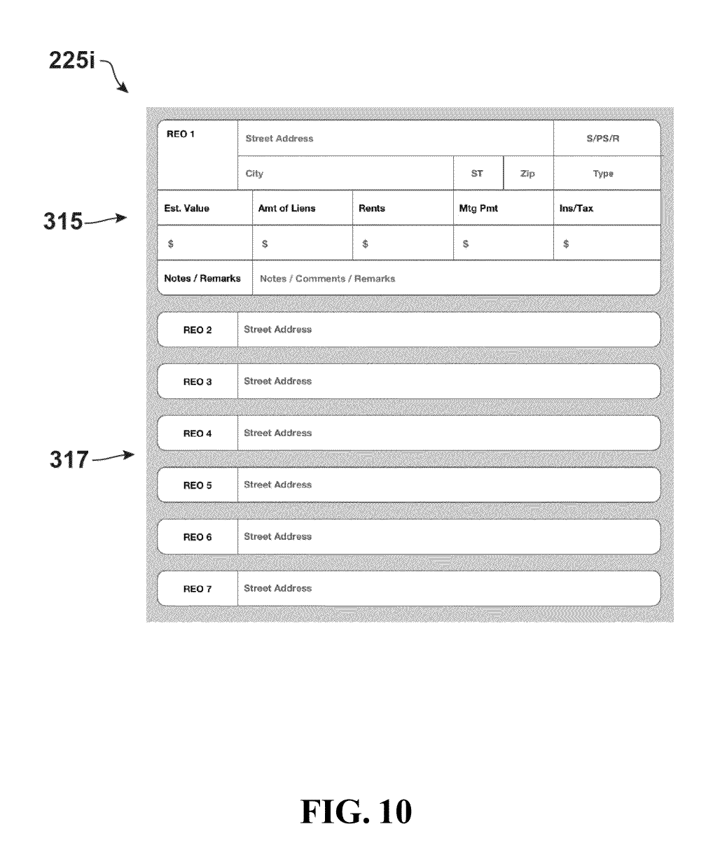

With respect to FIG. 10, the main program window 225i comprises information about real estate owned (REO) (that is, real estate foreclosed on by a lender), and allows the user to enter a first REO listing 315. The listing includes fillable fields for the address and type of the property, the estimated value, the amount of any liens, the amount of any rents received, the mortgage payment on the property, and the amount of any insurance and tax on the property. A field is also provided in the first REO listing 315 which allows the user to enter any remarks or noted on the property. A section 317 is also provided in the main program window 225 in which the user can enter addresses for other REOs. In some embodiments, section 317 may be expandable to accommodate the entry of information for additional REOs.

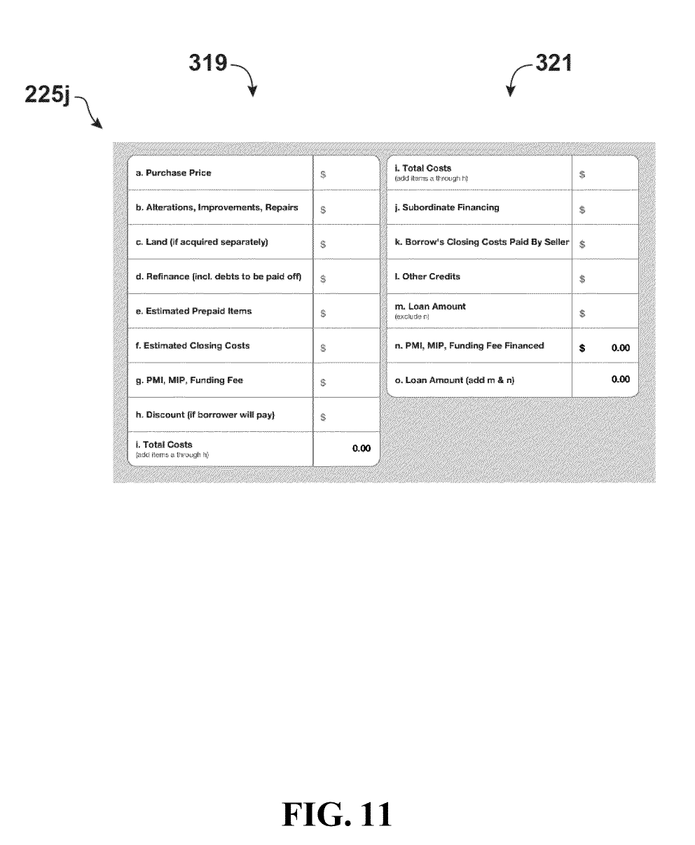

With respect to FIG. 11, the main program window 225j comprises first 319 and second 321 columns which allow the user to enter information which may affect the actual amount of the loan after adjustment to account for various items. These items include the purchase price of the property, the cost of alterations, improvements and repairs, the cost of the land (if purchased separately), refinance costs, estimated prepaid items, estimated closing costs, private mortgage insurance (PMI), mortgage insurance premiums (MIPs) and funding fees, discounts paid by the borrower, subordinate financing, closing costs paid by the seller, and other credits.

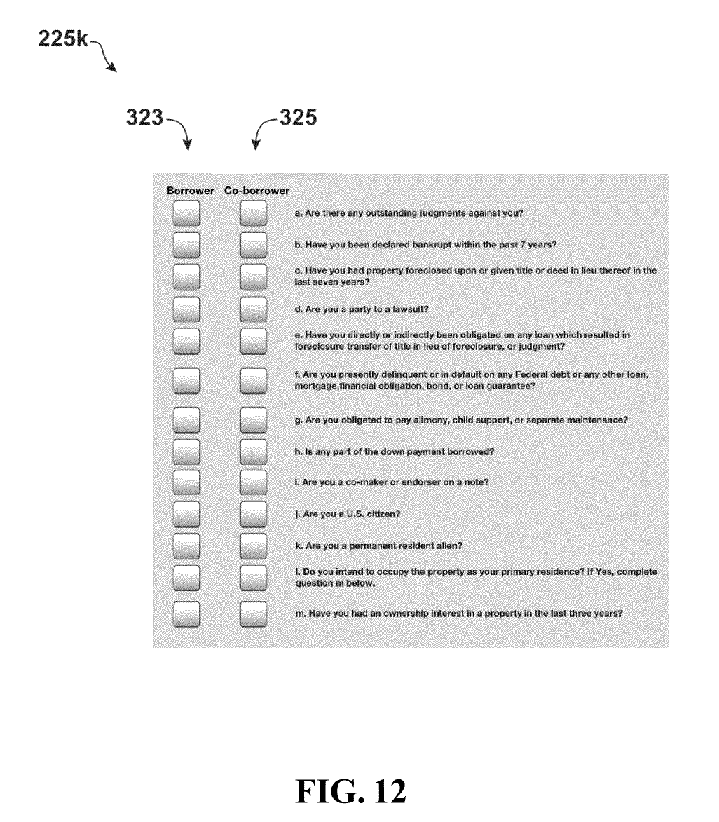

With respect to FIG. 12, the main program window 225k comprises a series of questions to be answered by the borrower and co-borrower with respect to potential liabilities. First 323 and second 325 columns of checkboxes are provided in which an affirmative response to each question may be indicated for the borrower or co-borrower, respectively. These questions address issues of outstanding judgments, bankruptcies, foreclosures, lawsuits, loan delinquencies, child support and alimony, borrowed portions of the down payment, endorsements on notes, citizenship, ownership of property, and the intended use of the property to which the loan being applied for relates.

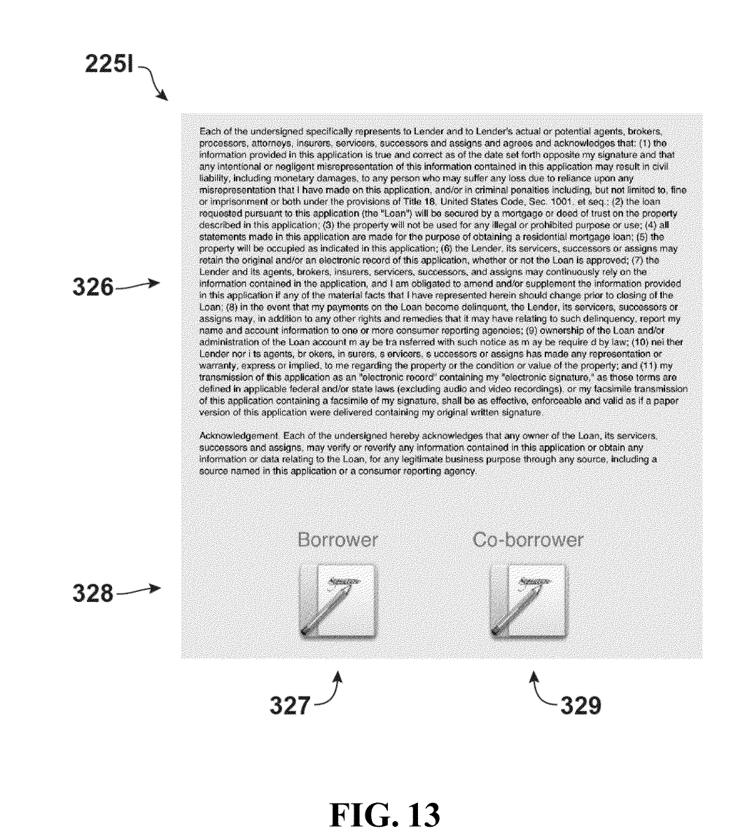

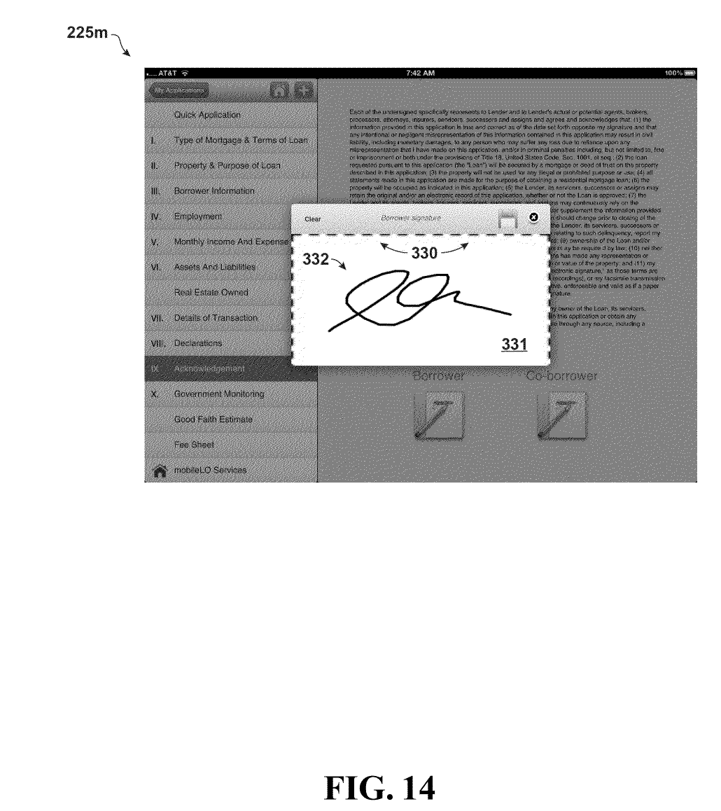

With respect to FIG. 13, the main program window 225l comprises a first portion 326 which sets forth contractual provisions related to the loan application, and a second portion 328 which contains signature icons for the borrower 327 and co-borrower 329. Each of the signature icons 327, 329, when selected, launches a pop-up window 331 (see, e.g., FIG. 14) in which the respective party enters a signature 332 to signal consent to the contractual terms set forth in the first portion 326.

With respect to FIG. 14, the main program window 225m comprises a pop-up window 331, overlaid on the main program window 225l of FIG. 13, on which the borrower can enter a signature 332 for recordation into the loan application. The signature 332 is preferably entered on a touch-sensitive pad or display and preferably with the signor's finger, but may also be entered by way of an electric stylus, by reading a digital signature that was previously stored, or by other suitable means. The pop-up window 331 is equipped with suitable controls 330 (in the embodiment depicted, these take the form of icons and/or hyperlinks) that give the user the option of clearing the signature 332, saving the signature 332 to file, or closing the pop-up window 331.

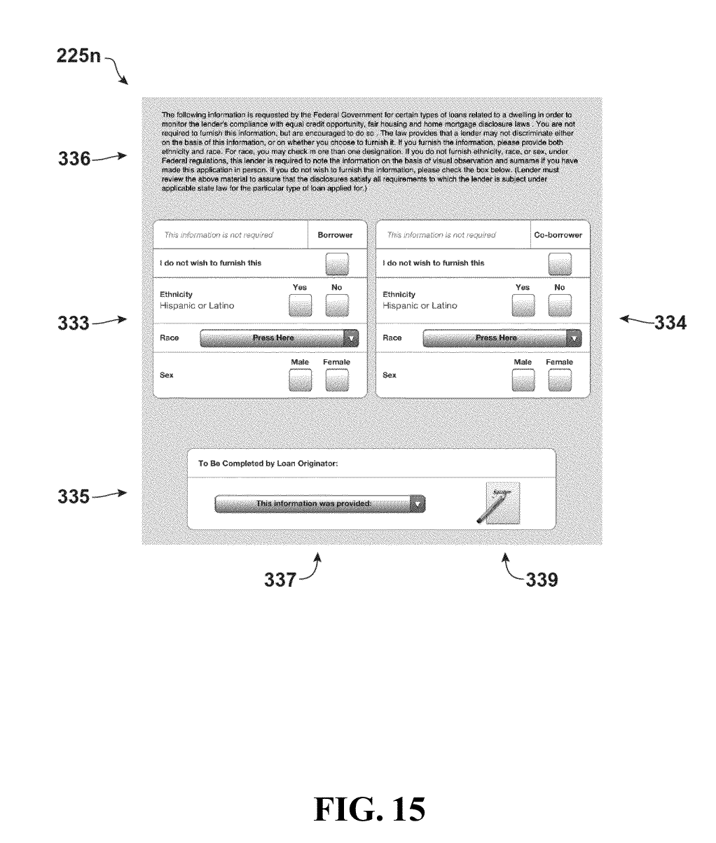

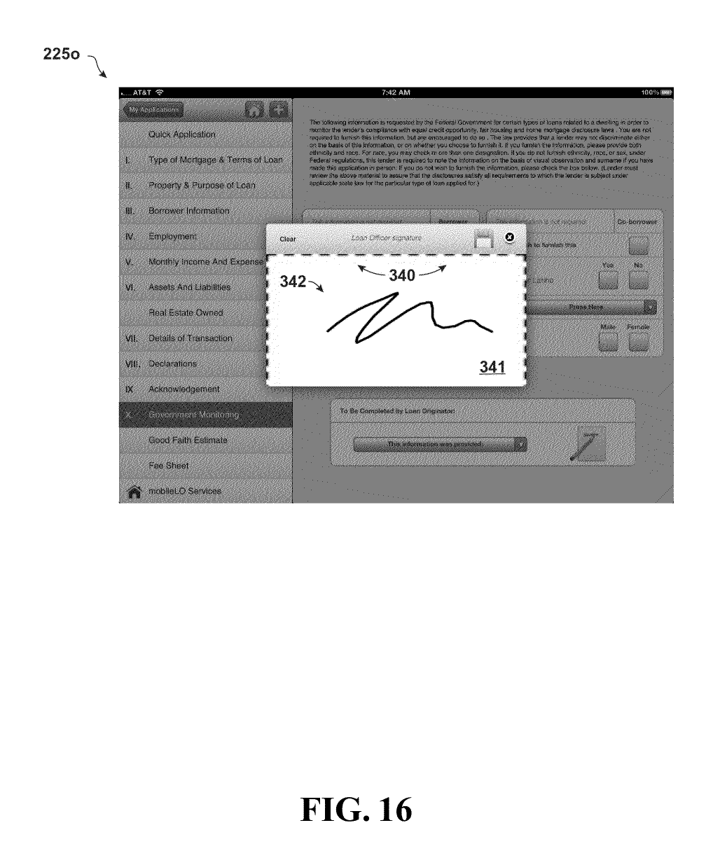

With respect to FIG. 15, the main program window 225n comprises information relating to equal credit opportunity laws. This includes a statement 336 of provisions in the equal credit opportunity, fair housing and home mortgage disclosure laws, and panes 333, 334 where the borrower and co-borrower, respectively, can voluntarily provide information about their ethnicity, race and sex. The main program window 225n further comprises a pane 335 where the loan originator (and more specifically, a loan officer working for the loan originator) can choose from a pull down menu 337 a description of the manner in which the information specified on the page was provided, and can enter a signature, through selection of a signature icon 339, to attest to the manner in which the information was provided. Selection of the signature icon 339 launches the pop-up window 341 depicted in FIG. 16.

With respect to FIG. 16, the main program window 225o comprises a pop-up window 341, overlaid on the main program window 225n of FIG. 15, on which the loan officer can enter a signature 342 for recordation into the loan application. The signature attests to the manner in which the information about the ethnicity, race and sex of the borrower and co-borrower was requested for the purposes of the equal credit opportunity, fair housing and home mortgage disclosure laws.

The signature 342 is preferably entered on a touch-sensitive pad or display and preferably with the signor's finger, but may also be entered by way of an electric stylus, by reading a digital signature that was previously stored, or by other suitable means. The pop-up window 341 is equipped with suitable controls 340 (in the embodiment depicted, these take the form of icons and/or hyperlinks) that give the user the option of clearing the signature 342, saving the signature 342 to file, or closing the pop-up window 341.

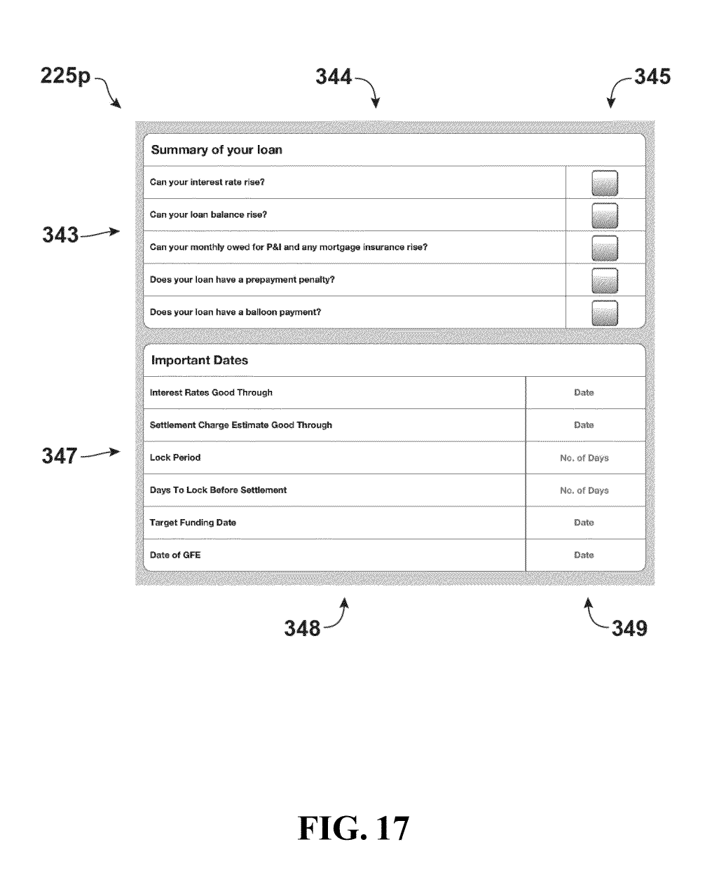

With respect to FIG. 17, the main program window 225p comprises a loan summary pane 343 and an important dates pane 347. The loan summary pane 343 includes a series of loan related questions 344 and a series of selectable buttons 345 that the user can select to obtain answers to those questions. The important dates pane 347 allows the user to enter information on important dates relating to the loan, and includes a second column 349 of the corresponding dates, and a first column 348 of the corresponding date descriptors.

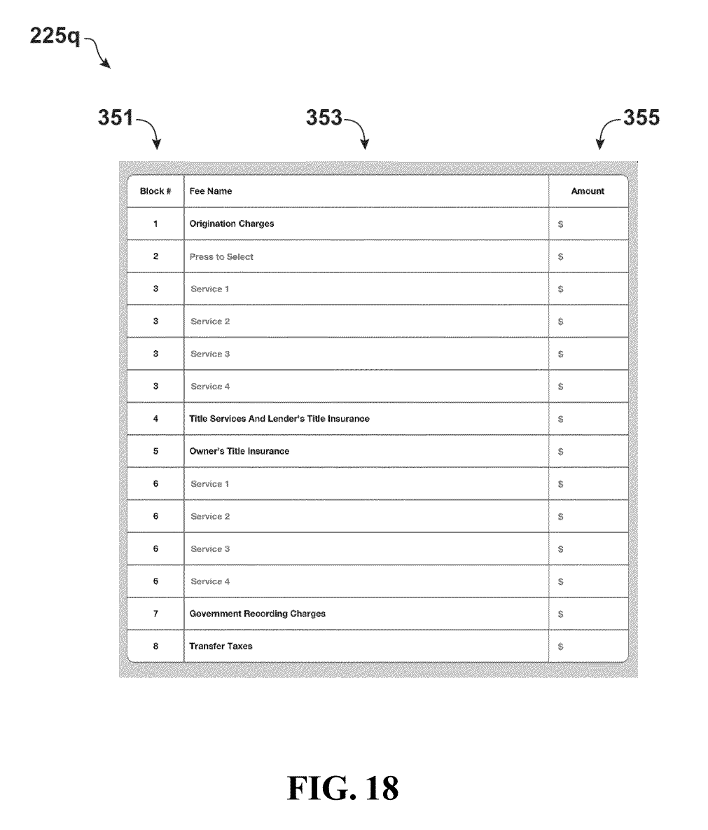

With respect to FIG. 18, the main program window 225q comprises a table in which the user can input loan processing fees. The table includes columns for fee identifiers 353 and the associated amount 355 and block number 351 for each processing fee related to the loan. Such fees include loan origination charges, title services, lender and owner's title insurance, government recording charges, and transfer taxes.

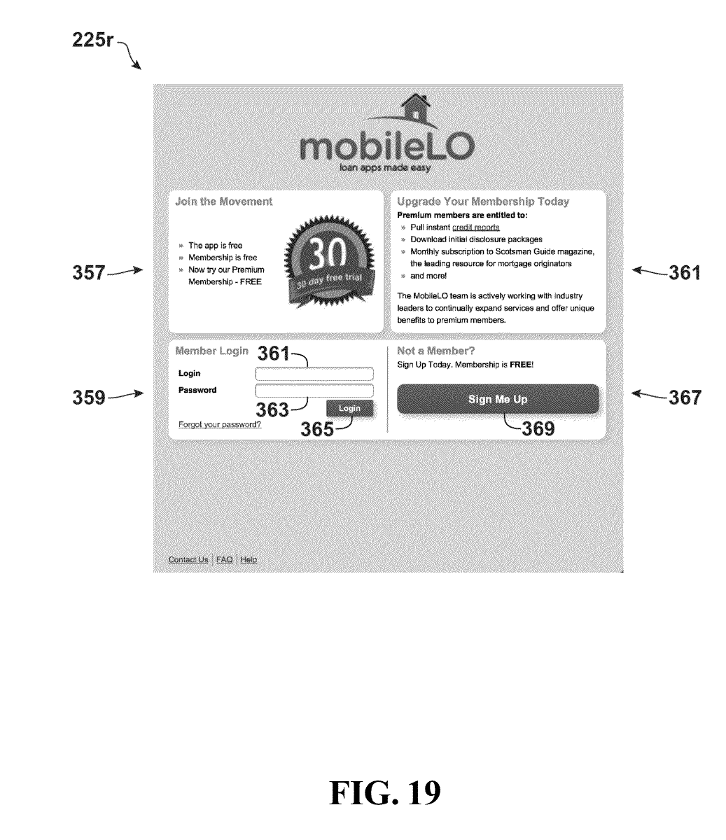

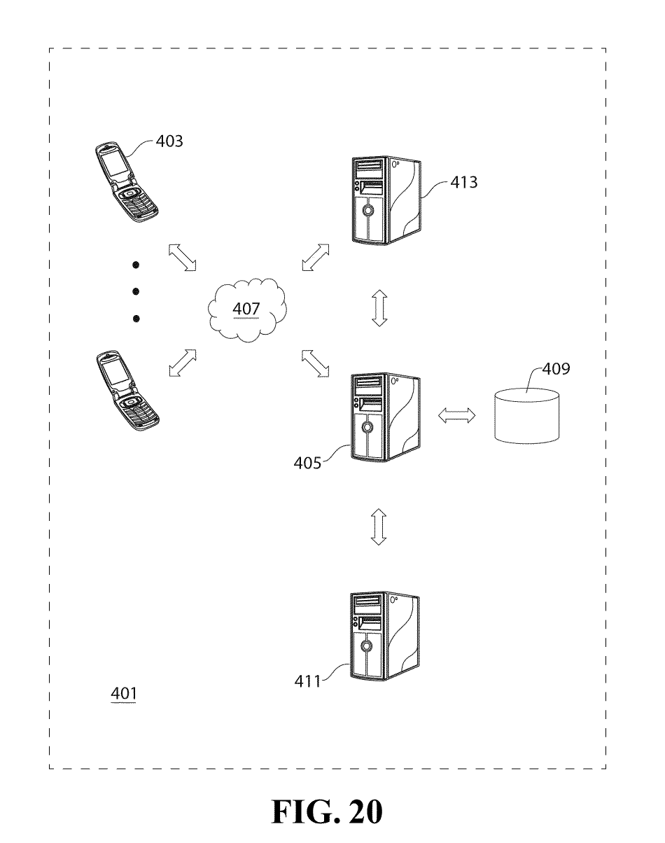

With respect to FIG. 19, the main program window 225r comprises a membership trial pane 357 which entices users of the software to take advantage of a free premium membership trial for a website and service associated with the software. A login pane 359 is provided for existing members to access their account on the website through the provision of a login 361 and password 363 and by further selecting a login button 365. A membership privileges pane 361 is provided which lists the advantages of premium membership, and a signup pane 367 is provided with a selectable signup button 369 that a user can utilize to obtain a free membership in the service.

FIG. 17 depicts a first particular, non-limiting embodiment of a system in accordance with the teachings herein. As seen therein, the system 401 comprises a plurality of mobile technology platforms 403 which are in communication with a server 405 over a network 407. Each mobile technology platform 403 is equipped with a display and a memory device and has an instance of a client software resident thereon of the type illustrated in FIGS. 1-16.

The server 405 includes, or is in communication with, a database 409 which contains, inter alia, information necessary to obtain any necessary or desired 3^{rd} party services. For example, database 409 may contain information necessary to obtain a credit report on the applicant. Hence, when a credit report is required, the server 405 generates the appropriate information on command, and then sends the information to—and obtains a credit report—from a second server 411 belonging to a third party credit reporting agency. In this way, a credit report may be requested by the client and subsequently downloaded without consuming undue resources on the host mobile technology platform 403. Preferably, the server 405 and the mobile technology platforms 403 are also in communication with a PC or server 413 which hosts the loan origination system.

It will be appreciated that the system 401 depicted in FIG. 17 may be utilized in a similar manner, and with similar advantages, to obtain any necessary or desired 3^{rd} party services in addition to credit reports. Thus, for example, the system 401 may be utilized to obtain appraisal orders, AVM (automated valuation models) orders (also known as automated appraisals), title/escrow report requests, or program/loan pricing (this displays rates on the subject loan program and credits/premiums for those specific interest rates). The system 401 may also be utilized to determine program/loan eligibility (that is, to ascertain whether a borrower meets loan program guidelines), to access automated underwriting systems (AUS) (these are integrations with the websites or servers of Fannie Mae and Freddie Mac), to interface with the websites or servers of 3^{rd} party lenders, to interface with vendors of document preparation or disclosure services, to obtain flood certification, to process hazard insurance requests, and to obtain verification of occupancy, employment and bank deposits.

The system 401 may also be utilized to establish FHA connections. This includes implementing case number queries and queries on the CAIVRS (Credit Alert Verification Reporting System) system, which is a federal government database of delinquent federal debtors.

Various modifications may be made to the systems, methodologies and software described herein. For example, the software illustrated in FIGS. 1-17 may include additional pages or features with additional functionalities thereon for addressing loan application issues. Moreover, the arrangement of the features set forth in these pages may be modified.

In addition, some embodiments of the systems, methodologies and software described herein may be equipped with the ability to import information into the loan application from various other forms or locations. In such cases, when the import feature is utilized, the fields in the application may be automatically populated.

While the systems, methodologies and software described herein are especially suitable for completing mortgage applications and applications for refinancing, various embodiments of these systems, methodologies and software may be utilized to complete various other types of loan applications as well. In some cases, suitable modifications may be made to tailor these systems, methodologies and software to the particular loan in question.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A mobile technology platform for processing loan applications, comprising:
a display; and
a non-transitory, computer readable medium;
wherein said medium has recorded therein a software program containing suitable programming instructions which, when executed, causes to be displayed on the display a screen having (a) an index portion with a plurality of index items listed therein, wherein each index item pertains to a loan-related topic, and (b) a page display portion; wherein each of said plurality of index items is linked to a page having disposed thereon at least one fillable field relating to said loan application topic; and wherein selecting one of said at least one index items causes the corresponding linked page to be displayed on the page display portion.

2. The mobile technology platform of claim 1, wherein each index item is linked to a unique page.

3. The mobile technology platform of claim 1, wherein said index portion is displayed on the left side of the display, and wherein said page display portion is displayed on the right side of the display.

4. The mobile technology platform of claim 1, wherein said index portion and said page display portion are displayed on the display in a side-by-side manner.

5. The mobile technology platform of claim 1, wherein one of said index items relates to a borrower's employment history.

6. The mobile technology platform of claim 1, wherein one of said index items relates to a borrower's real estate property.

7. The mobile technology platform of claim 1, wherein one of said index items relates to a borrower's monthly income and expenses.

8. The mobile technology platform of claim 1, wherein one of said index items relates to a borrower's assets and liabilities.

9. The mobile technology platform of claim 1, wherein one of said plurality of index items is linked to a page having disposed thereon a first field for inputting the address of the property for which a mortgage is being sought and a second field for inputting the current address of the borrower, and wherein the page is further equipped with a button which, when selected, populates the second field with the data entered in the first field.

10. The mobile technology platform of claim 1, wherein a loan application being processed on the mobile technology platform names a borrower, and wherein one of said plurality of index items is linked to a first page having disposed thereon a first signature icon for the borrower which, when selected, launches a first touch-sensitive pop-up window equipped with a first signature field in which the borrower's signature may be entered.

11. The mobile technology platform of claim 10, wherein the loan application being processed on the mobile technology platform names a co-borrower, wherein said first page has disposed thereon a second signature icon for the co-borrower which, when selected, launches a second touch-sensitive pop-up window equipped with a second signature field in which the co-borrower's signature may be entered.

12. The mobile technology platform of claim 1, wherein selecting an index item in the index portion causes the selected index item to be highlighted.

13. A method for completing a loan application, comprising:
providing a mobile technology platform equipped with a display and a non-transitory, computer readable medium having recorded therein a software program containing suitable programming instructions which, when executed, causes to be displayed on the display a screen having (a) an index portion with a plurality of index items listed therein, wherein each index item pertains to a loan-related topic, and (b) a page display portion; wherein each of said plurality of index items is linked to a page having disposed thereon at least one fillable field relating to said loan application topic, and wherein selecting one of said at least one index items causes the corresponding linked page to be displayed on the page display portion; and
for each index item, (a) selecting the index item, and (b) entering information in the page display portion corresponding to the index item.

14. The method of claim 13, wherein the software program further contains suitable programming instructions which, when executed, cause the fields in a loan application form to be populated based on the information entered in each page display portion.

15. The method of claim 13, wherein said index portion and said page display portion are displayed on the display in a side-by-side manner.

16. The method of claim 13, wherein one of said index items relates to a borrower's employment history.

17. The method of claim 13, wherein one of said index items relates to a borrower's real estate property.

18. The method of claim 13, wherein one of said index items relates to a borrower's monthly income and expenses.

19. The method of claim 13, wherein one of said index items relates to a borrower's assets and liabilities.

20. A system for processing loan applications, comprising:
a plurality of mobile technology platforms;
a first server in communication with each of said plurality of mobile technology platforms over a network; and
a database in communication with said first server;
wherein each of said plurality of mobile technology platforms has an instance of a client resident thereon and is equipped with a display; wherein said client causes to be displayed on the display a screen having (a) an index portion with a plurality of index items listed therein, and (b) a page display portion; wherein each of said plurality of index items is linked to a page having disposed thereon at least one fillable field relating to a loan application topic; and wherein selecting one of said at least one index items causes the corresponding linked page to be displayed on the page display portion.

21. The system of claim 20, wherein each of said plurality of mobile technology platforms has a non-transitory, computer readable medium associated therewith which has an instance of said client recorded therein.

22. The system of claim 21, wherein said client is a software program containing suitable programming instructions which, when executed, cause to be displayed on the display the screen having said index portion and said display portion.

23. The system of claim 20, further comprising a second server which is in communication with said first server and which contains the records of a credit reporting agency.
